(19) United States
(12) Patent Application Publication
(10) Pub. No.: US 2026/0086792 A1
(43) Pub. Date: Mar. 26, 2026

(54) OPTIMIZING SOFTWARE UPGRADE PROCESSES IN DATA CENTER ARCHITECTURES

(71) Applicant: Hewlett Packard Enterprise Development LP, Spring, TX (US)

(72) Inventors: Srinivas Subbarao Mulgund, Bangalore (IN); Jayadev Mandya Sudarshan Kumar Jain, Bangalore (IN); Rohit Bangalore Vijaya, Bangalore (IN); Sravanthi Rapa, Bangalore (IN)

(21) Appl. No.: 18/976,824

(22) Filed: Dec. 11, 2024

(30) Foreign Application Priority Data
Sep. 25, 2024 (IN) 202441072537

(51) Int. Cl. G06F 8/65; G06F 11/3698

(52) U.S. Cl. CPC G06F 8/65; G06F 11/3698

(57) ABSTRACT

In certain implementations, a system includes one or more processors, and one or more non-transitory computer-readable storage media storing programming for execution by the one or more processors, the programming including instructions to obtain version information for a plurality of software and firmware sub-components of a service pack installed on a computer system, input the obtained version information into a trained neural network model, receive, from the trained neural network model, a prediction of a service pack version corresponding to the plurality of software and firmware sub-components, determine, based on the predicted service pack version, a compatible target service pack for the computer system, and initiate an upgrade process to install the compatible target service pack on the computer system.

### BACKGROUND

Disaggregated Hyper-Converged Infrastructure (dHCI) is a data center architecture that combines the scalability of traditional Hyper-Converged Infrastructure (HCI) with the flexibility and cost-efficiency of disaggregated resources. The dHCI architecture decouples compute, storage, and networking resources into separate pools that can be scaled independently based on workload requirements. The dHCI may include one or more servers that perform the compute functions of the data center. For example, these one or more servers may run various applications, host virtual machines, and process data. The dHCI may also include storage systems that store and manage an organization's data. These storage systems may be used to provide access to information for applications and users.

The dHCI may also include a unified management platform, which is a software solution that provides centralized control and monitoring of data center resources. Service packs are collections of updates, fixes, and enhancements released by software and hardware vendors. These service packs may be used to keep the firmware and software components of dHCI solutions up to date. For example, a service pack may include a comprehensive collection of firmware and software updates for the one or more servers, including system ROM, device drivers, management agents, and utilities. By regularly applying service packs to the compute, storage, and management components of a dHCI solution, organizations can ensure optimal performance, stability, and security while benefiting from the flexibility and scalability provided by the dHCI.

### BRIEF DESCRIPTION OF THE DRAWINGS

Aspects of the present disclosure are best understood from the following detailed description when read with the accompanying figures.

FIG. 1A illustrates an example system of a Disaggregated Hyper-Converged Infrastructure (dHCI) solution on which an upgrade process may be performed to upgrade a base service pack that is installed on a compute node of the system to a target service pack, according to some implementations.

FIG. 1B illustrates an example implementation of a computer system 150 that can utilize processes according to some implementations.

FIG. 2 illustrates an example process for upgrading a base service pack that is installed on a compute node of a system, the example process including an inferencing workflow, according to some implementations.

FIG. 3 illustrates a training workflow for training a CNN model that may be used to predict the base service pack version that is installed on a compute node of a system, according to some implementations.

FIG. 4 illustrates an example method for upgrading a base service pack that is installed on a compute node of a system to a target service pack, according to some implementations.

FIG. 5 illustrates an example method for upgrading a base service pack that is installed on a compute node of a system to a target service pack, according to some implementations.

### DESCRIPTION

Current dHCI solutions may offer one or more upgrade features to simplify the process of updating firmware and software components, including the applying of a target service pack to a compute node (e.g., a server or storage). However, the one or more upgrade features may lack a mechanism to accurately identify the base service pack version that is already installed on the compute node. The base service pack may include a collection of sub-components (e.g., firmware and software components such as, for example, system Read Only Memory (ROM), Basic Input/Output System (BIOS) settings, device drivers, network adapters, management agents, and utilities) that are tested and validated together to ensure compatibility and stability when running on the compute node. A dHCI catalog may refer to a collection of base service pack versions that are suitable for use in a respective dHCI solution.

A problem can arise when clients manually perform out-of-band firmware and/or software updates on the sub-components of the base service pack, which can lead to mismatches between the actual installed firmware and/or software versions and the expected firmware and/or software versions defined in the dHCI solution's validated dHCI catalog. These mismatches occur when firmware and/or software updates are performed independently on the sub-components of the base service pack. As a result, the one or more upgrade features may fail to update the firmware and/or software components when executed, as the one or more upgrade features may be unable to verify the compatibility of the currently installed base service pack version with the target service pack version.

In addition, updating from the installed base service pack version may require a multi-step process, involving an update to a compatible intermediate service pack version, before ultimately updating to the target service pack version. If the one or more upgrade features are unable to verify the installed base service pack version, it may be unable to determine the appropriate upgrade path to update to the target service pack version. This may result in the one or more upgrade features failing to update the firmware and software components when executed. Furthermore, the one or more upgrade features may fail to update the firmware and software components when executed if the compute node is currently in an unstable state as a result of a previous unsuccessful upgrade attempt.

Certain implementations of this disclosure provide techniques for accurately identifying the installed base service pack version on a compute node in a dHCI solution, determining a target service pack version to apply to the compute node based on the identified installed base service pack version, and determining a compatible upgrade path to the target service pack version. The dHCI solution may provide an upgrade feature, which when initiated, utilizes an Application Programming Interface (API) to retrieve data about the currently installed versions of the base service pack sub-components, including firmware and software components such as, for example, system ROM, BIOS settings, device drivers, network adapters, management agents, and utilities.

The retrieved data about the sub-component versions may then be input into a pre-trained Convolutional Neural Network (CNN) model, which predicts the most probable installed base service pack version based on learned patterns and features. The CNN model may include three parallel networks, with each parallel network having a different filter size than the other parallel networks. The outputs of the three parallel networks may then be concatenated, and the concatenated outputs may be passed through a dense layer to predict the installed base service pack version.

The CNN model may be trained on a dataset of, e.g., over 20, supported base service pack versions. In addition, to further train the CNN model, the dataset may also include randomized orders of the sub-component versions within each of the base service pack versions. Once the base service pack version that is installed on the compute node is identified, an upgrade module may consider a compatibility matrix that specifies valid upgrade paths and the base service pack versions of the dHCI catalog. The upgrade module may determine the highest compatible target service pack version from the dHCI catalog, and identify the appropriate upgrade path. The upgrade module may then perform steps to upgrade the base service pack installed on the compute node to the target service pack.

Certain implementations of this disclosure may provide one or more technical advantages. For example, certain implementations may allow for the accurate identification of the base service pack version that is installed on a compute node in a dHCI solution, even when the actual installed firmware and/or software versions of the sub-components of the base service pack are mismatched from the expected firmware and/or software versions defined in the dHCI solution's validated dHCI catalog. By leveraging the trained CNN model to predict the installed base service pack version based on the retrieved data about the sub-component versions, the disclosed solution may achieve a high level of accuracy (e.g., 95% or more) in identifying the actual installed base service pack version. This accurate identification may enable the upgrade module to determine the highest compatible target service pack version from the dHCI catalog, and a compatible upgrade path to the target service pack version. The upgrade module may then perform an upgrade process to upgrade the base service pack that is installed on the compute node to the target service pack, while reducing a risk of failure and improving the reliability of the upgrade process. In addition, these implementations allow for the automating of the upgrade process, which result in minimizing the need for manual intervention and troubleshooting. This in turn may lead to improved system availability, reduced support costs, and enhanced customer satisfaction.

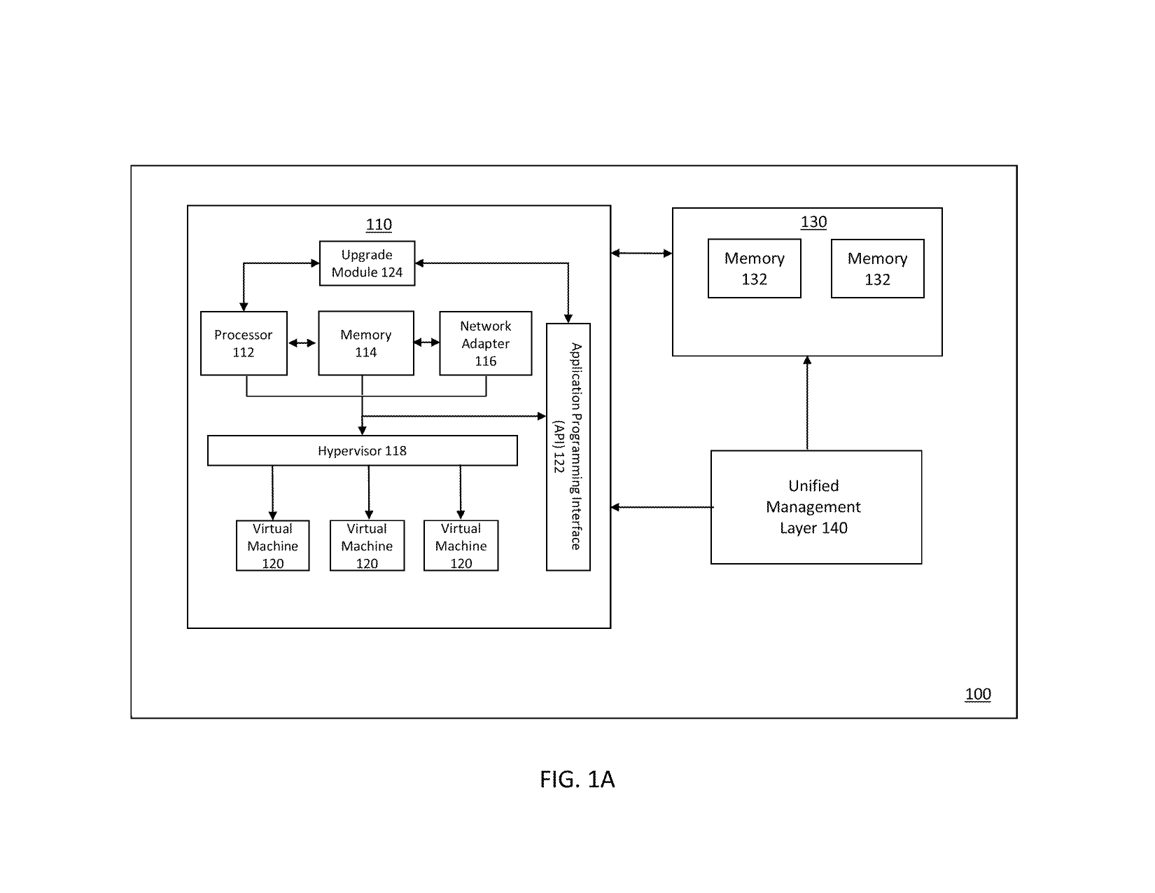

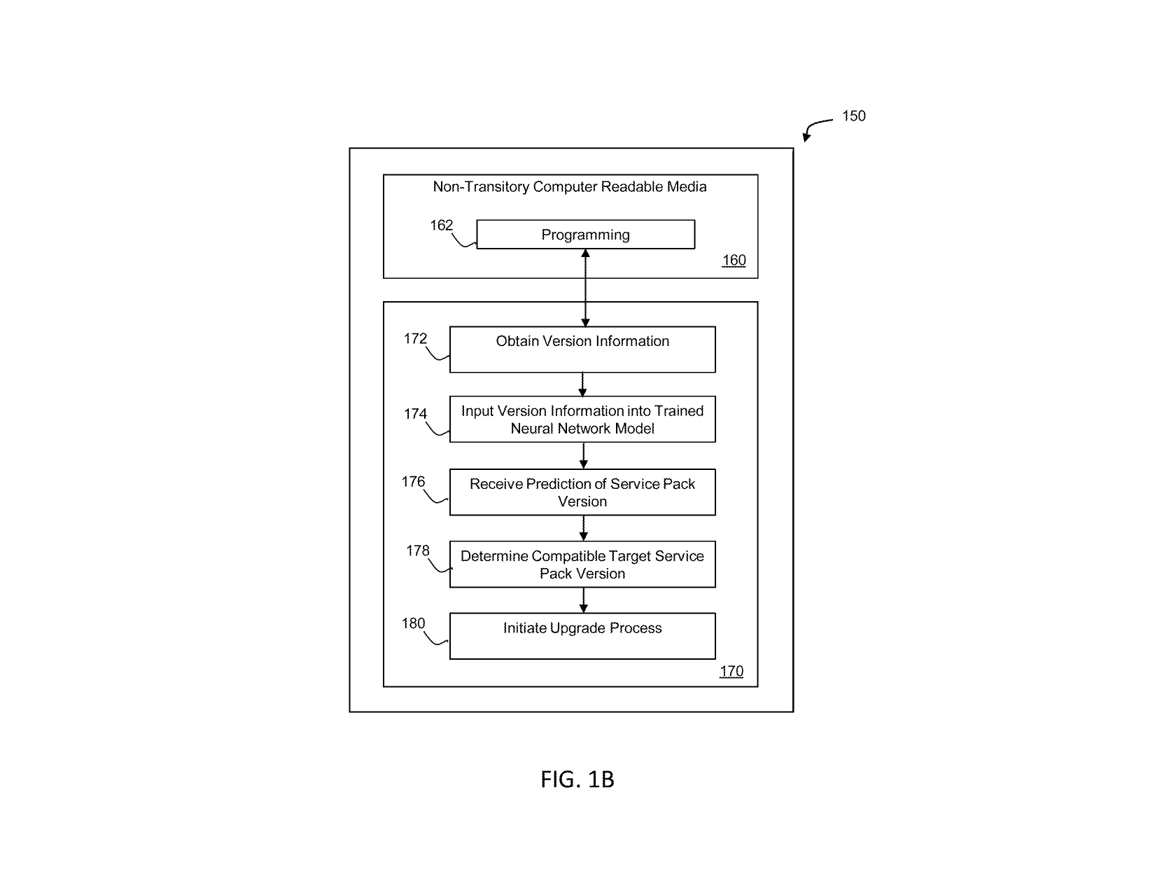

FIG. 1A illustrates an example system 100 of a Disaggregated Hyper-Converged Infrastructure (dHCI) solution that includes a compute node 110 and a storage node 130, which are managed by a unified management layer 140. In an implementation, the dHCI solution may include more than one compute node 110. An upgrade process may be performed to upgrade a base service pack that is installed on the compute node 110 of the system 100 to a target service pack. The compute node 110 may be, for example, a server that provides the computational resources for the dHCI solution. For example, the compute node 110 may run the workloads and applications that the dHCI solution supports.

In an implementation, the compute node 110 of the system 100 includes a processor 112, which may perform a variety of operations such as executing a hypervisor 118 (described below), running virtual machines 120 (described below), performing computations for an upgrade module 124 (described below), and managing interactions with the unified management layer 140 (e.g., sending status updates, receiving upgrade instructions). The processor 112 may include one or more programmable logic devices, microprocessors, application-specific integrated circuits (ASICs), controllers, or any other suitable computing devices or resources or any combination of the preceding. The compute node 110 may include any suitable numbers and types of processors 112. In certain implementations, the processor 112 may be or may include a central processing unit (CPU).

In an implementation, the compute node 110 of the system 100 may include a memory 114, which may include a non-transitory computer readable medium that stores programming for execution by the processor 112. The memory 114 may provide fast, temporary storage for data and instructions that are actively used by the processor 112. This includes running processes, running the virtual machines 120, and potentially caching update packages or scripts during the upgrade process. The compute node 110 of the system 100 may also include a network adapter 116 that may include an Ethernet adapter, or other network interfaces that facilitate communication within the dHCI environment and over external networks. The network adapter 116 may facilitate transmission of data between the compute node 110 and other components of the system 100 (e.g., the storage node 130, the unified management layer 140) as well as external systems.

In an implementation, the compute node 110 may run the hypervisor 118, which is a software layer that manages the hardware resources of the compute node 110 and enables the creation and operation of multiple virtual machines 120. The hypervisor 118 may be, for example, any virtualization platform suitable for enterprise environments. The hypervisor 118 may play a role in resource allocation and isolation, allowing multiple workloads to run concurrently on the same physical hardware. In an implementation, the upgrade process may also include updating the hypervisor 118 to ensure compatibility with the target service pack and to leverage new features or security improvements. The virtual machines 120 may represent individual, isolated computing environments running on top of the hypervisor 118. Each virtual machine 120 can run its own operating system and applications, providing flexibility and efficient resource utilization within the dHCI solution. The compute node 110 may host multiple virtual machines 120, each allocated a portion of the compute node 110 resources by the hypervisor 118.

The compute node 110 of the system 100 may include the upgrade module 124, which is responsible for managing the upgrade process in the dHCI solution. The upgrade module 124 may be implemented as a software component that orchestrates the upgrade from the base service pack version installed on the compute node 110 to the target service pack version. The upgrade module 124 may interact with other components of the system 100 through the Application Programming Interface (API) 122 to gather necessary data and execute upgrade commands. While FIG. 1A shows the upgrade module 124 as part of the compute node 110, the upgrade module 124 can alternatively be implemented on a remote computer system. In such a configuration, the sub-component version data gathered via the API 122 and any other relevant system data may be communicated from the compute node 110 to the remote upgrade module via the network adapter 116.

The API 122 may be used to provide a standardized method for components of the system 100 to interact (e.g., such as to request and to exchange data) within the system 100. The API 122 may be implemented, for example, as a Redfish API, that is designed for managing modern server hardware. The API 122 may be utilized by the upgrade module 124 to gather data about the system 100, such as current firmware and software versions of the sub-components of the base service pack installed on the compute node 110.

The system 100 may include a storage node 130, which may represent the disaggregated storage component of the dHCI solution. The storage node 130 may be, for example, a storage array. The storage node 130 may include multiple memory units 132, and these memory units 132 may include, for example, solid-state drives (SSDs) and/or hard disk drives (HDDs). In an implementation, the storage node 130 may run its own operating system. The storage node 130 may communicate with the compute node 110 via high-speed network connections, facilitated by the network adapter 116. In an implementation, the upgrade process managed by the upgrade module 124 may also include updating the storage node 130 components, such as the operating system that runs on the storage node 130, to ensure compatibility and optimal performance with the upgraded compute node 110.

The system 100 may include a unified management layer 140, which manages both the compute node 110 and storage node 130 of the dHCI solution. It may provide a single interface for administrators to control the entire system 100. In an implementation, during the upgrade process to upgrade the base service pack version installed on the compute node 110 to the target service pack version, the unified management layer 140 works with the upgrade module 124 to coordinate updates across the sub-components of the compute node 110. It may also offer a dashboard (e.g., a display component, such as for example, a display screen), for administrators to view the system 100 status, including a predicted version of the installed base service pack.

While not explicitly shown, other components can be upgraded in the process. For example, Field-Programmable Gate Arrays (FPGAs) can be reconfigured at runtime through software updates to implement different algorithms or functions. Network Interface Cards (NICs) can include firmware that can be updated to support new features or protocols. Graphics Processing Units (GPUs) can utilize driver updates to introduce new features or address performance issues. System-on-a-Chip (SoC) devices can also utilize firmware updates to modify the behavior of these components or introduce new features. Other Internet-of-Things (IOT) components might also be updatable.

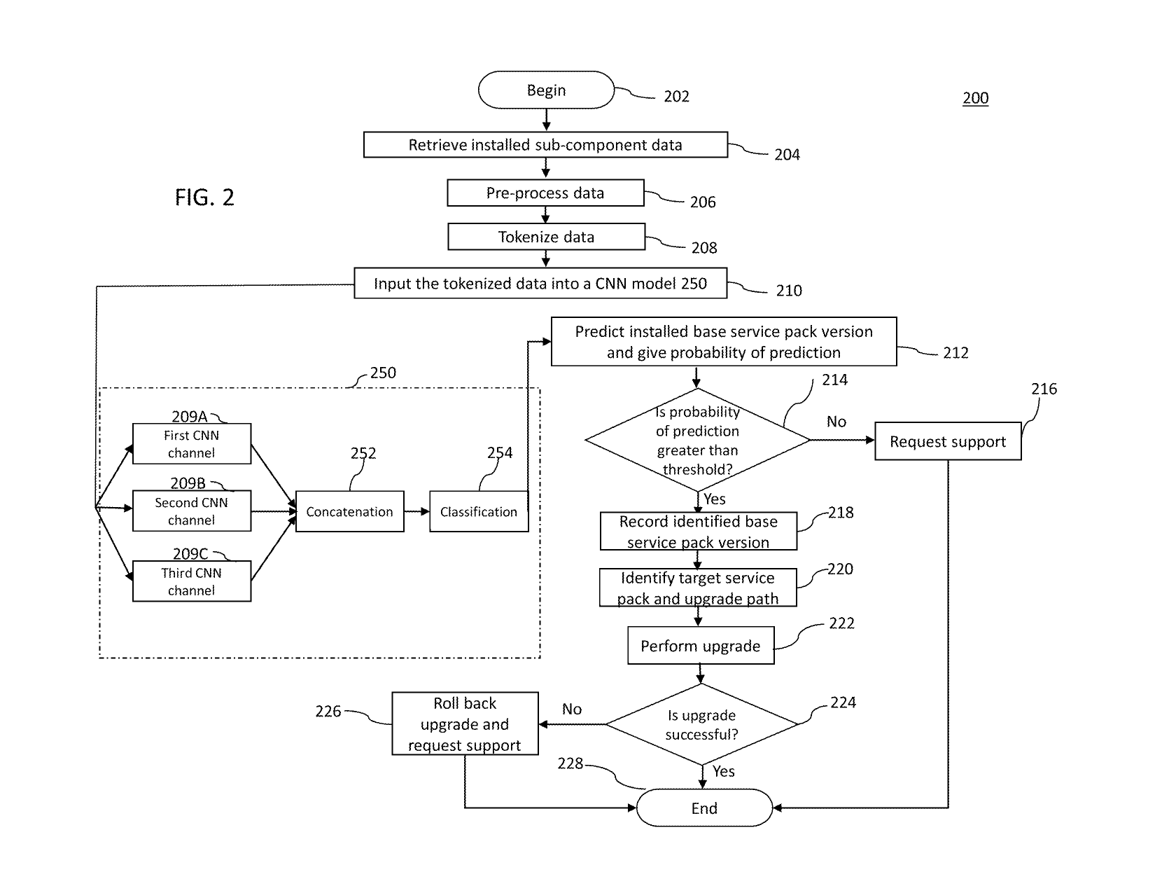

FIG. 1B depicts an example implementation of a computer system 150 that can utilize processes disclosed herein. The computer system is part of computer system 100 shown in FIG. 1A. For example, the system 150 may be a sub-system of the system 100. Further details of the process are provided in FIG. 2.

As shown in FIG. 1B, the computer system 150 comprises one or more processors 170 and one or more non-transitory computer-readable storage media 160 storing programming 162 for execution by the one or more processors 170. The programming comprises instructions 172-180 to obtain version information for a plurality of software and firmware sub-components of a service pack installed on a computer system (172). The obtained version information is input into a trained neural network mode (174). A prediction of a service pack version corresponding to the plurality of software and firmware sub-components is received from the trained neural network model (176). A compatible target service pack for the computer system is determined based on the predicted service pack version (178). An upgrade process can be initiated to install the compatible target service pack on the computer system (180).

FIG. 2 illustrates a flowchart 200 of a process for upgrading a base service pack that is installed on a compute node (e.g., the compute node 110 described previously in FIG. 1A) of a system (e.g., the system 100 of the dHCI solution described previously in FIGS. 1A-1B) to a target service pack. The upgrade process illustrated in the flowchart 200 may include an inferencing workflow in which a pre-trained Convolutional Neural network (CNN) model 250 is used to process tokenized sub-component version data to generate a prediction for the base service pack version that is installed on the compute node 110, and to generate a probability score for this prediction. The upgrade process (and the inferencing workflow that is included within the upgrade process) depicted in FIG. 2 may be performed using the components and architecture described in FIGS. 1A-1B, although other architectures could also utilize the process. The upgrade process may be initiated using, for example, an upgrade feature that is provided by the dHCI solution. Once the upgrade feature is activated (e.g., by using an input such as a mouse input, or a keyboard input), the upgrade feature may aim to simplify and streamline the upgrade process for upgrading the base service pack that is installed on the compute node 110, as well as additional upgrade processes for the hypervisor 118 and the storage node 130. However, the flowchart 200 may illustrate only the upgrade process for the compute node 110.

Step 202 of the flowchart 200 marks the beginning of an example of the upgrade process that was described previously in FIGS. 1A-1B. The upgrade process may be initiated by, for example, activating the upgrade feature (e.g., by using an input such as a mouse input or a keyboard input) that may be provided by the dHCI solution. The upgrade process may also be automated, e.g., set to be performed at predetermined times or under predetermined conditions.

In step 204, the upgrade module 124 may send a request through the API 122 to retrieve data about the versions of the base service pack’s sub-components that are currently installed on the compute node 110. These sub-components may include firmware and software components such as, for example, system Read Only Memory (ROM), Basic Input/Output System (BIOS) settings, device drivers, network adapters, management agents, and utilities. The API 122 may be, for example, a Redfish API, that provides a standardized method for gathering data about the system 100. In an implementation, the retrieved data may include version details for 20 or more sub-components of the base service pack installed on the compute node 110. In other implementations, the retrieved data may include version details for any number of sub-components of the base service pack installed on the compute node 110.

In step 206, the upgrade module 124 may perform a data preparation process on the data about the versions of the base service pack’s sub-components that was retrieved in the step 204. This may involve, for example, performing a data clean up process on the retrieved data by removing any invalid entries, standardizing version number formats, and ensuring consistency across all the retrieved data. After the data clean up process is performed, the upgrade module 124 may structure the cleaned data into a delineated string. This may involve, for example, arranging the version numbers of each sub-component of the base service pack, separated by commas (or any other delineator). This creates a uniform representation of the sub-component versions of the base service package, regardless of their original format or the specific configuration of the compute node 110. The resulting string maintains the relationship between each sub-component of the base service pack and its version.

In step 208, the upgrade module 124 uses a predefined data map to convert the delineated string of sub-component versions that were created previously in the step 206 into tokens. To do this, the upgrade module 124 may for example, transform each element in the delineated string (e.g., representing a sub-component version) into a corresponding token based on a saved data map. This saved data map may contain rules or mappings that associate specific sub-component versions or patterns with numerical or categorical tokens. The resulting set of tokens may now form a uniform, machine-readable representation of the sub-component versions. These tokens are therefore standardized, numerical representations of the sub-component versions installed on the compute node 110.

Step 210, step 252, step 254, and step 212 represent the inferencing workflow for an inferencing process that is used to generate a prediction for the base service pack version that is installed on the compute node 110, and to generate a probability score for this prediction. The inferencing workflow is included within the upgrade process that is illustrated in the flowchart 200.

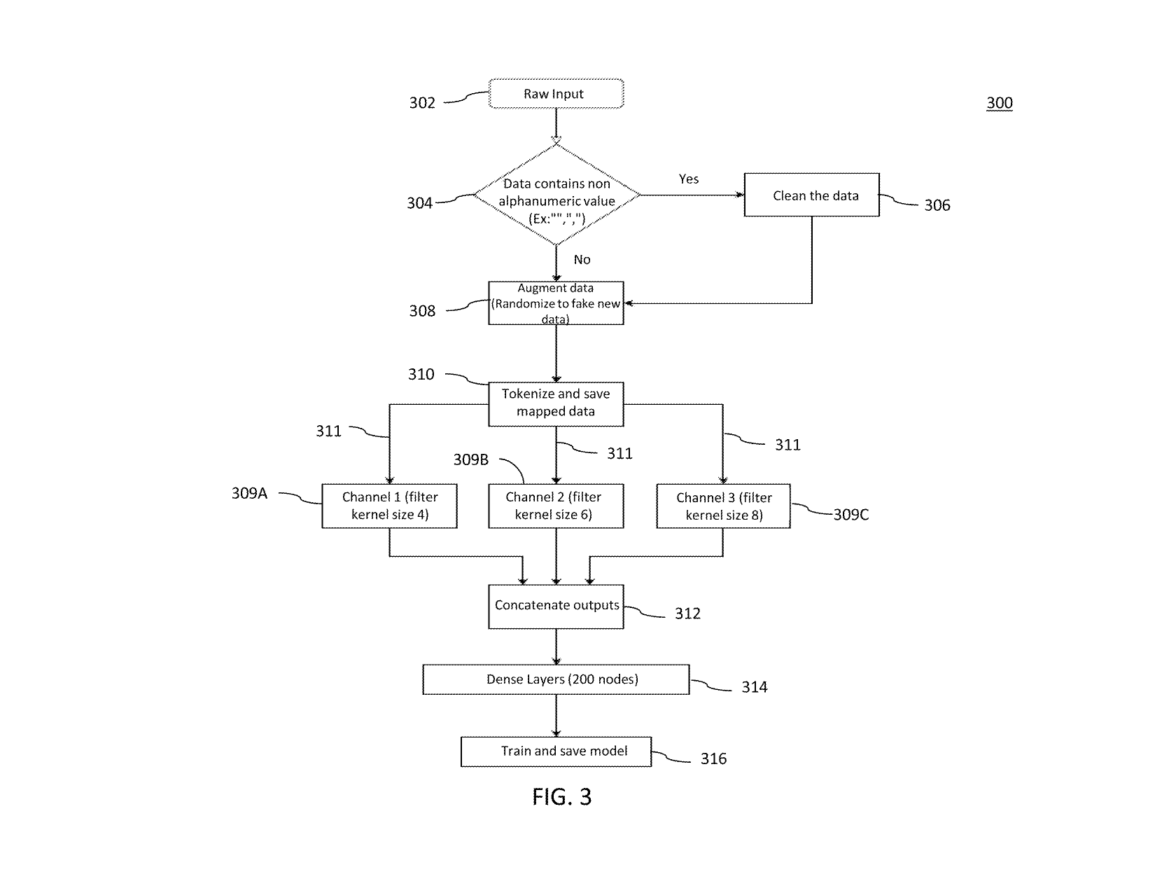

In step 210, the tokenized sub-component version data that was prepared previously in the step 208 is input into the pre-trained Convolutional Neural Network (CNN) model 250. The CNN model 250 may process the tokenized sub-component version data using a plurality of subsequent steps (e.g., the step 252, the step 254, and the step 212). A process for training the CNN model 250 is described subsequently in FIG. 3.

In an implementation in which the upgrade module 124 and the CNN model 250 are installed directly on the compute node 110 of the system 100 described previously in FIGS. 1A-1B, the CNN model 250 may run on the processor 112 of the compute node 110. In other implementations where the upgrade module 124 is implemented on a remote computer system that is different from the system 100 described previously in FIG. 1A, the CNN model 250 may run on the remote computer system. The CNN model 250 may include a three-channel architecture that includes a first CNN channel 209A, a second CNN channel 209B, and a third CNN channel 209C. For example, the first CNN channel 209A, the second CNN channel 209B, and the third CNN channel 209C may be networks that operate in parallel to each other. In other implementations, the CNN model 250 may include any number of CNN channels.

The input data (e.g., the tokenized sub-component version data) may be simultaneously processed in parallel by each of the first CNN channel 209A, the second CNN channel 209B, and the third CNN channel 209C. In an implementation, each of the first CNN channel 209A, the second CNN channel 209B, and the third CNN channel 209C may utilize different filter sizes during the processing of the tokenized sub-component version data to detect patterns at various scales in the input data (e.g., the tokenized sub-component version data). These filters may be learned patterns that the CNN model 250 uses to detect specific features in the input data. For example, in an implementation, the first CNN channel 209A may employ filters with a size of 3, the second CNN channel 209B may employ filters with a size of 5, and the third CNN channel 209C may employ filters with a size of 7. In other implementations, the first CNN channel 209A, the second CNN channel 209B, and the third CNN channel 209C may employ filters of any size that are different from each other.

The different filters of the first CNN channel 209A, the second CNN channel 209B, and the third CNN channel 209C may be composed of learned weight matrices. These weights may determine how input features are combined to create higher-level features. For example, certain weight configurations might be particularly sensitive to specific sub-component version patterns, allowing the CNN model 250 to detect these patterns in the input data.

After the tokenized sub-component version data has been processed in parallel using the first CNN channel 209A, the second CNN channel 209B, and the third CNN channel 209C, the outputs of each of the first CNN channel 209A, the second CNN channel 209B, and the third CNN channel 209C are combined together (e.g., by using the outputs of each of the first CNN channel 209A, the second CNN channel 209B, and the third CNN channel 209C as an input for a concatenation layer of the CNN model 250) to form a concatenated output as shown in the step 252.

The concatenated output from the step 252 described above may then be input into a dense layer (also referred to as a fully connected layer) of the CNN model 250 as shown in the step 254 to perform a final classification and prediction of the base service pack version that is installed on the compute node 110. In an implementation, the dense layer applies additional learned weights to perform the final classification and prediction of the base service pack version installed on the compute node 110. In an implementation, the dense layer may include, for example, 150-250, e.g., 200, nodes, each with its own set of weights. The number of nodes and associated weights may vary based on the specific requirements of the prediction task and the complexity of the input data. These weights in the dense layer determine how the multi-scale features from previous layers are combined and transformed. The dense layer processes the weighted input to generate a prediction for the base service pack version and a probability score for this prediction. The predicted version may be the base service pack version with the highest probability score, while the probability score for this prediction may indicate the CNN model 250’s confidence in this prediction. In an implementation, the probability score may be expressed as a percentage (e.g., in a range from 0 percent to 100 percent.)

In the step 212 of the flowchart 200, the prediction for the base service pack version and the probability score for this prediction may be displayed on a dashboard (e.g., a display component, such as for example, a display screen) of the unified management layer 140 that was described previously in FIG. 1A. In an implementation, the CNN model 250 may encompass elements that include the first CNN channel 209A, the second CNN channel 209B, the third CNN channel 209C, the concatenation layer of the step 252, and the dense layer of the step 254, all of which utilize learned weights to process and analyze the input data (e.g., the tokenized sub-component version data prepared in the step 208.

In step 214 of the flowchart 200, the upgrade module 124 may determine whether the probability score of the predicted version of the base service pack (described previously in the step 212) meets or exceeds a predefined threshold value. In an implementation, the predefined threshold value may be, for example, 95 percent. If during the step 214 it is determined that the probability score of the predicted version of the base service pack is less than the predefined threshold value, a warning message may be displayed on a dashboard (e.g., a display component, such as for example, a display screen) of the unified management layer 140 as shown in step 216 of the flowchart 200. The warning message may, for example, notify a user that the version of the base service pack installed on the compute node 110 cannot be determined. In addition, the warning message may request the user to seek technical support. After displaying the warning message, the upgrade process is terminated, as marked by the step 228 of the flowchart 200.

If during the step 214 it is determined that the probability score of the predicted version of the base service pack is equal to or exceeds the predefined threshold value, the upgrade module 124 may identify the predicted base service pack version as the base service pack version that is installed on the compute node 110, and record the identified base service pack version and its probability score in a database as shown in step 218 of the flowchart 200. The database may utilize, for example, the storage capabilities of the storage node 130 that was described previously in FIG. 1A.

In step 220, the upgrade module 124 may use catalog logic to identify a target service pack and determine an appropriate upgrade path for the compute node 110. Catalog logic may refer to a set of rules and procedures for determining compatible base service pack versions and appropriate upgrade paths within the dHCI solution. For example, the upgrade module 124 may consider a compatibility matrix that specifies valid upgrade paths and the base service pack versions of the dHCI catalog. The upgrade module 124 may then determine the highest compatible base service pack version from the dHCI catalog, and identify the highest compatible base service pack version as the target service pack version to be installed on the compute node 110 of the system 100. In addition, the upgrade module 124 may also identify the appropriate upgrade path to reach the target service pack version. For example, upgrading from the installed base service pack version may require a multi-step process, involving an upgrade to a compatible intermediate service pack version, before ultimately updating to the target service pack version.

In step 222, the upgrade module may perform steps to upgrade the base service pack installed on the compute node 110 to the target service pack that was identified previously in the step 220. In addition, the steps to upgrade the base service pack to the target service pack may be performed along the appropriate upgrade path that was identified previously in the step 220.

In step 224, the upgrade module 124 may determine whether the upgrade from the base service pack to the target service pack described in the step 222 was successful. If during the step 224 it is determined that the upgrade from the base service pack to the target service pack was not successful, the upgrade module 124 may perform a rollback procedure as shown in step 226, to restore the previous base service pack version that was installed on the compute node 110 before the upgrade process was initiated. In addition, a warning message may be displayed on a dashboard (e.g., a display component, such as for example, a display screen) of the unified management layer 140. The warning message may, for example, request the user to seek technical support. After displaying the warning message, the upgrade process is terminated, as marked by the step 228 of the flowchart 200. If during the step 224 it is determined that the upgrade from the base service pack to the target service pack was successful, the upgrade process for upgrading the base service pack installed on the compute node 110 of the system 100 to the target service pack is complete, as marked by the step 228 of the flowchart 200.

FIG. 3 illustrates a flowchart 300 that depicts the training workflow of a CNN model. For example, the flowchart 300 may show a process for training the CNN model (e.g., the CNN model 250 described previously in FIG. 2) that may be used to predict the base service pack version that is installed on a compute node (e.g., the compute node 110 described previously in FIGS. 1-2). In an implementation, the training process described in the flowchart 300 may be performed in a controlled development environment. In an implementation, the CNN model may be re-trained using the training process described in the flowchart 300 after every successful upgrade of a base service pack that is installed on a compute node (e.g., the compute node 110 described previously in FIG. 1A) to a target service pack.

Step 302 may represent raw input data that may be used to train the CNN model (e.g., the CNN model 250 described previously in FIG. 2). The raw input data may include comma-separated sub-component versions that make up various base service pack configurations. The raw input data may be derived from known, supported base service pack versions. In an implementation, the raw input data may be derived from 20 or more supported base service pack versions. In an implementation, each entry (which may also be referred to as a base service package dataset) in the raw input data may represent a specific base service pack version and may include version information for 20 or more sub-components. These sub-components may include firmware and software components such as, for example, system Read Only Memory (ROM), Basic Input/Output System (BIOS) settings, device drivers, network adapters, management agents, and utilities.

In step 304, an evaluation may be performed to determine if the raw input data from the step 302 contains any non-alphanumeric values. If it is determined in the step 304 that the raw input data does contain non-alphanumeric values, a data clean up process may be performed as shown in step 306 to remove or standardize the non-alphanumeric values. In other implementations, other clean up steps can be used to be sure the inputs are uniform, e.g., non-alphanumeric values are used consistently.

If it is determined in the step 304 that the raw input data does not contain non-alphanumeric values, or after the data clean up process of the step 306 is performed, a step 308 may be performed. In step 308, the raw input data is augmented to generate 17 randomized versions of the input data for each base service pack version. The augmentation process for the raw input data may include randomizing the order of the sub-component versions within each base service package dataset. As a result of this randomization, an expanded dataset can be generated from each base service package dataset. After the augmentation process is performed, the expanded dataset may be split, with 70 percent of the expanded dataset being reserved for subsequent training of the CNN model (e.g., the CNN model 250 described previously in FIG. 2) and 30 percent of the expanded dataset being reserved for subsequent validation of the CNN model.

In step 310, the augmented data from the step 308 may be converted into tokens. To do this, a predefined data map may be used to transform each element of the augmented data into a corresponding token. This may include, for example, assigning a unique numerical or categorical value to each sub-component version in the augmented dataset. The predefined data map may include a comprehensive set of rules or mappings that associate specific sub-component versions with standardized token values. The resulting tokenized data may form a uniform, machine-readable representation of the sub-component versions for each augmented version of the base service pack data. The tokenized data may subsequently saved using a suitable storage mechanism. This may include storing the tokenized data in a database, file system, or other appropriate data storage solution. The saved, tokenized data may be suitable for use in training the CNN model (e.g., the CNN model 250 described previously in FIG. 2). For example, 70 percent of the tokenized data may be allocated for the training the CNN model 250 and 30 percent of the tokenized data reserved for validation of the CNN model 250.

In step 311, the tokenized data from the step 310 (e.g., the 70 percent of the tokenized data that was reserved for the training of the CNN model 250) may be used as an input for each of three parallel CNN channels (e.g., first CNN channel 309A, second CNN channel 309B, and third CNN channel 309C) of the CNN model, the three CNN channels of the CNN model having different filter kernel sizes (e.g., 4, 6, and 8). The tokenized data may be simultaneously input into each of the three CNN channels for processing. Using the same tokenized data as input for the three CNN channels, and the three CNN channels having different filter kernel sizes (e.g., 4, 6, and 8), allows the CNN model (e.g., the CNN model 250 described previously in FIG. 2) to learn to recognize patterns at multiple scales simultaneously.

In step 312, the outputs from the three CNN channels (e.g., the first CNN channel 309A, the second CNN channel 309B, and the third CNN channel 309C) may be combined into a single, larger feature representation. This concatenated output may serve as a comprehensive representation of the input data (e.g., the tokenized data of the step 310), and may capture both fine-grained and broader patterns in the sub-component version information.

In step 314, the concatenated output from the step 312 may be used as input data for a plurality of dense layers. Each dense layer of the plurality of dense layers may include, for example, 150 to 250, e.g., 200, nodes. The plurality of dense layers may process the input data (e.g., the concatenated output from the step 312) through a series of weighted calculations and non-linear activations. As the input data passes through these layers, the CNN model (e.g., the CNN model 250 described previously in the FIG. 2) may learn to identify complex patterns in the input data (e.g., the concatenated output from the step 312) and map them to specific base service pack versions. In an implementation, during the step 314, the weights associated with each node may be iteratively adjusted to optimize the CNN model's (e.g., the CNN model 250 described previously in the FIG. 2) ability to recognize relevant features and make accurate predictions.

In step 316, the CNN model (e.g., the CNN model 250 described previously in the FIG. 2) may be trained and saved. The CNN model may be trained using training data that includes, for example, the 70 percent of the tokenized data from the step 310 that was allocated for training the CNN model. The CNN model may process the training data, make predictions of base service pack versions, and compare these predictions to actual base service pack versions. The CNN model may adjust its weights based on the errors calculated, and repeat this process multiple times to improve accuracy. The CNN model's performance may be periodically checked using validation data that includes, for example, the 30 percent of the tokenized data reserved for validation of the CNN model. Once training is complete and performance is satisfactory, the CNN model may be saved. The CNN model may subsequently be used to predict a base service pack version installed on a compute node (e.g., the compute node 110 described previously in FIG. 1A) during an upgrade process to upgrade the installed base service pack to a target service pack.

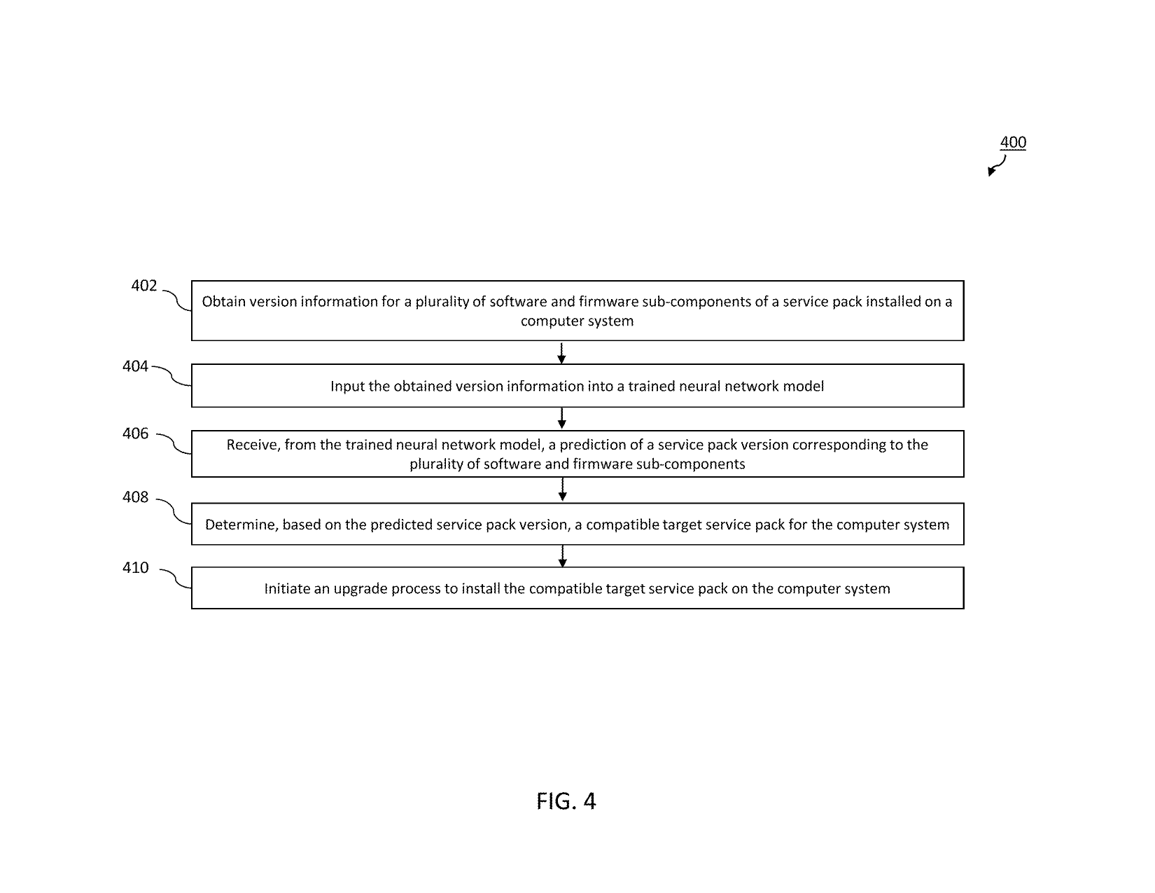

FIG. 4 illustrates an example method 400 for upgrading a base service pack that is installed on a compute node (e.g., the compute node 110 described previously in FIG. 1A) of a system (e.g., the system 100 of the dHCI solution described previously in FIGS. 1A-1B) to a target service pack. In step 402, version information for a plurality of software and firmware sub-components of a service pack installed on a computer system may be obtained. For example, the upgrade module 124 may send a request through the API 122 to retrieve data about the versions of the base service pack’s sub-components that are currently installed on the compute node 110. These sub-components may include firmware and software components such as, for example, system Read Only Memory (ROM), Basic Input/Output System (BIOS) settings, device drivers, network adapters, management agents, and utilities.

In step 404, the obtained version information is inputted into a trained neural network model. For example, as described previously in the step 206 of FIG. 2, the upgrade module 124 may perform a data clean up process on the data about the versions of the base service pack’s sub-components that was retrieved in the step 204 of FIG. 2, by removing any invalid entries, standardizing version number formats, and ensuring consistency across all the retrieved data. After the data clean up process is performed, the upgrade module 124 may structure the cleaned data into a comma-separated string. Next, as described previously in the step 208 of FIG. 2, the upgrade module 124 may use a predefined data map to convert the comma-separated string of sub-component versions that were created previously in the step 206 into tokens. To do this, the upgrade module 124 may for example, transform each element in the comma-separated string (e.g., representing a sub-component version) into a corresponding token based on a saved data map. After the conversion of the comma-separated string of sub-component versions into tokens, the tokenized sub-component version data may be input into the pre-trained Convolutional Neural Network (CNN) model 250 as described previously in the step 210 of FIG. 2.

In step 406, a prediction of a service pack version corresponding to the plurality of software and firmware sub-components is received from the trained neural network model. For example, the tokenized sub-component version data described previously in the step 208 of the FIG. 2 may be processed in parallel using the first CNN channel 209A, the second CNN channel 209B, and the third CNN channel 209C of the CNN model 250. The outputs of each of the first CNN channel 209A, the second CNN channel 209B, and the third CNN channel 209C may then be combined together (e.g., by using the outputs of each of the first CNN channel 209A, the second CNN channel 209B, and the third CNN channel 209C as an input for a concatenation layer of the CNN model 250) to form a concatenated output as shown in the step 252 of the FIG. 2.

The concatenated output may then be input into a dense layer (also referred to as a fully connected layer) of the CNN model 250 as shown in the step 254 of the FIG. 2 to perform a final classification and prediction of the base service pack version that is installed on the compute node 110. The dense layer may process the input (e.g., the concatenated output from the step 252) to generate a prediction for the base service pack version that is installed on the compute node 110, and a probability score for this prediction.

In step 408, a compatible target service pack for the computer system is determined based on the predicted service pack version. For example, the upgrade module 124 may use catalog logic to identify a target service pack and determine an appropriate upgrade path for the compute node 110 as described previously in the step 220 of FIG. 2. The upgrade module 124 may consider a compatibility matrix that specifies valid upgrade paths and the base service pack versions of the dHCI catalog. The upgrade module 124 may then determine the highest compatible base service pack version from the dHCI catalog, and identify the highest compatible base service pack version as the target service pack version to be installed on the compute node 110 of the system 100. In addition, the upgrade module 124 may also identify the appropriate upgrade path to reach the target service pack version.

In step 410, an upgrade process to install the compatible target service pack on the computer system is initiated. For example, as described previously in the step 222 of the FIG. 2, the upgrade module may perform steps to upgrade the base service pack installed on the compute node 110 to the target service pack. In addition, the steps to upgrade the base service pack to the target service pack may be performed along the appropriate upgrade path.

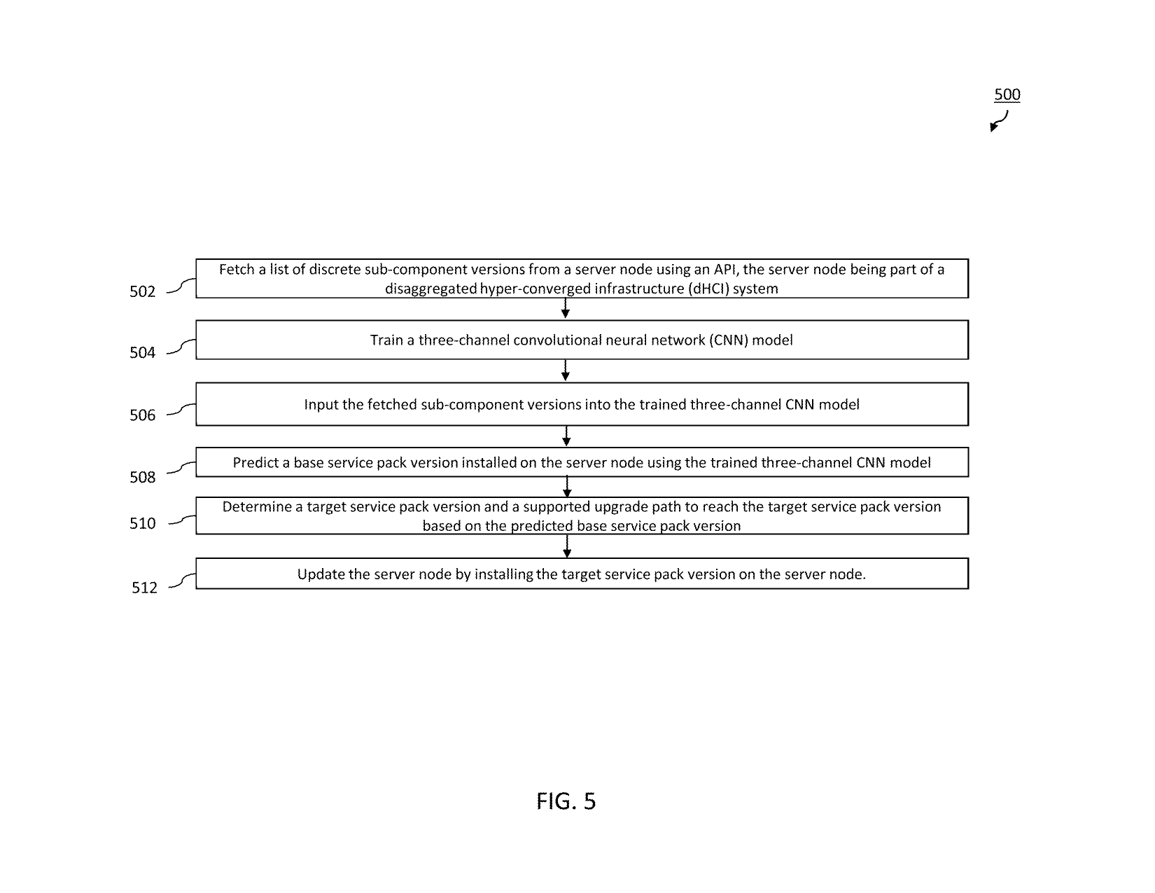

FIG. 5 illustrates an example method 500 for upgrading a base service pack that is installed on a compute node (e.g., the compute node 110 described previously in FIG. 1A) of a system (e.g., the system 100 of the dHCI solution described previously in FIG. 1A-1B) to a target service pack. In step 502, a list of discrete sub-component versions is fetched from a server node using an API, the server node being part of a disaggregated hyper-converged infrastructure (dHCI) system. For example, the upgrade module 124 may send a request through the API 122 to retrieve data about the versions of the base service pack’s sub-components that are currently installed on the compute node 110. These sub-components may include firmware and software components such as, for example, system Read Only Memory (ROM), Basic Input/Output System (BIOS) settings, device drivers, network adapters, management agents, and utilities.

In step 504, a three-channel convolutional neural network (CNN) model is trained. For example, the process for training a CNN model that is described in the flowchart 300 of FIG. 3 may be performed to train the CNN model 250 (described previously in FIG. 2) to predict the base service pack version that is installed on the compute node 110.

In step 506, the fetched sub-component versions are inputted into the trained three-channel CNN model. For example, as described previously in the step 206 of FIG. 2, the upgrade module 124 may perform a data clean up process on the data about the versions of the base service pack’s sub-components that was retrieved in the step 204 of FIG. 2, by removing any invalid entries, standardizing version number formats, and ensuring consistency across all the retrieved data. After the data clean up process is performed, the upgrade module 124 may structure the cleaned data into a comma-separated string. Next, as described previously in the step 208 of FIG. 2, the upgrade module 124 may use a predefined data map to convert the comma-separated string of sub-component versions that were created previously in the step 206 into tokens. To do this, the upgrade module 124 may for example, transform each element in the comma-separated string (e.g., representing a sub-component version) into a corresponding token based on a saved data map. After the conversion of the comma-separated string of sub-component versions into tokens, the tokenized sub-component version data is input into the pre-trained Convolutional Neural Network (CNN) model 250 as described previously in the step 210 of FIG. 2.

In step 508, a base service pack version installed on the server node is predicted using the trained three-channel CNN model. For example, the tokenized sub-component version data described previously in the step 208 of the FIG. 2 may be processed in parallel using the first CNN channel 209A, the second CNN channel 209B, and the third CNN channel 209C of the CNN model 250. The outputs of each of the first CNN channel 209A, the second CNN channel 209B, and the third CNN channel 209C may then be combined together (e.g., by using the outputs of each of the first CNN channel 209A, the second CNN channel 209B, and the third CNN channel 209C as an input for a concatenation layer of the CNN model 250) to form a concatenated output as shown in the step 252 of the FIG. 2.

The concatenated output may then be input into a dense layer (also referred to as a fully connected layer) of the CNN model 250 as shown in the step 254 of the FIG. 2 to perform a final classification and prediction of the base service pack version that is installed on the compute node 110. The dense layer may process the input (e.g., the concatenated output from the step 252) to generate a prediction for the base service pack version that is installed on the compute node 110, and a probability score for this prediction.

In step 510, a target service pack version and a supported upgrade path to reach the target service pack version is determined based on the predicted base service pack version. For example, the upgrade module 124 may use catalog logic to identify a target service pack and determine an appropriate upgrade path for the compute node 110 as described previously in the step 220 of FIG. 2. The upgrade module 124 may consider a compatibility matrix that specifies valid upgrade paths and the base service pack versions of the dHCI catalog. The upgrade module 124 may then determine the highest compatible base service pack version from the dHCI catalog, and identify the highest compatible base service pack version as the target service pack version to be installed on the compute node 110 of the system 100. In addition, the upgrade module 124 may also identify the appropriate upgrade path to reach the target service pack version.

In step 512, the server node is updated by installing the target service pack version on the server node. For example, as described previously in the step 222 of the FIG. 2, the upgrade module may perform steps to upgrade the base service pack installed on the compute node 110 to the target service pack. In addition, the steps to upgrade the base service pack to the target service pack may be performed along the appropriate upgrade path.

It should be understood that the systems and methods described in this disclosure may be combined in any suitable manner.

Although this disclosure describes or illustrates particular operations as occurring in a particular order, this disclosure contemplates the operations occurring in any suitable order. Moreover, this disclosure contemplates any suitable operations being repeated one or more times in any suitable order. Although this disclosure describes or illustrates particular operations as occurring in sequence, this disclosure contemplates any suitable operations occurring at substantially the same time, where appropriate. Any suitable operation or sequence of operations described or illustrated herein may be interrupted, suspended, or otherwise controlled by another process, such as an operating system or kernel, where appropriate. The acts can operate in an operating system environment or as stand-alone routines occupying all or a substantial part of the system processing.

The foregoing outlines features of several examples so that those skilled in the art may better understand the aspects of the present disclosure. Various modifications and combinations of the illustrative examples, as well as other examples, will be apparent to persons skilled in the art upon reference to the description. It is therefore intended that the appended claims encompass any such modifications.

What is claimed is:

1. A system, comprising:
one or more processors; and
one or more non-transitory computer-readable storage media storing programming for execution by the one or more processors, the programming comprising instructions to:
obtain version information for a plurality of software and firmware sub-components of a service pack installed on a computer system;
input the obtained version information into a trained neural network model;
receive, from the trained neural network model, a prediction of a service pack version corresponding to the plurality of software and firmware sub-components;
determine, based on the predicted service pack version, a compatible target service pack for the computer system; and
initiate an upgrade process to install the compatible target service pack on the computer system.

2. The system of claim 1, wherein the trained neural network model is a Convolutional Neural Network (CNN) model.

3. The system of claim 2, wherein the CNN model comprises three parallel networks, each of the three parallel networks having a different filter size from the other parallel networks.

4. The system of claim 1, wherein the programming comprises further instructions to:
receive, from the trained neural network model, a probability score that indicates a confidence of the trained neural network model in the prediction of the service pack version.

5. The system of claim 1, wherein inputting the obtained version information into the trained neural network model comprises:
performing a data preparation process to convert the obtained version information into a delineated string; and
converting the delineated string into tokens using a predefined data map.

6. The system of claim 1, wherein obtaining the version information for the plurality of software and firmware sub-components of the service pack installed on the computer system comprises sending a request, via an Application Programming Interface (API), to the computer system to retrieve the version information for the plurality of software and firmware sub-components.

7. A computer-implemented method, comprising:
obtaining version information for a plurality of software and firmware sub-components of a service pack installed on a computer system;
inputting the obtained version information into a trained neural network model;
receiving, from the trained neural network model, a prediction of a service pack version corresponding to the plurality of software and firmware sub-components;
determining, based on the predicted service pack version, a compatible target service pack for the computer system; and
initiating an upgrade process to install the compatible target service pack on the computer system.

8. The computer-implemented method of claim 7, wherein obtaining the version information for the plurality of software and firmware sub-components of the service pack comprises:
sending a request, via an Application Programming Interface (API), to the computer system to retrieve the version information for the plurality of software and firmware sub-components.

9. The computer-implemented method of claim 8, wherein the plurality of software and firmware sub-components of the service pack comprise at least 20 sub-components.

10. The computer-implemented method of claim 7, wherein inputting the obtained version information into the trained neural network model comprises:
performing a first data preparation process on the obtained version information to remove invalid entries in the obtained version information;
after performing the first data preparation process, performing a second data preparation process to convert the obtained version information into a delineated string; and
converting the delineated string into tokens using a predefined data map.

11. The computer-implemented method of claim 10, wherein inputting the obtained version information into the trained neural network model further comprises inputting the tokens into the trained neural network model.

12. The computer-implemented method of claim 11, wherein the trained neural network model is a Convolutional Neural Network (CNN) model.

13. The computer-implemented method of claim 12, wherein the CNN model comprises three parallel networks, each of the three parallel networks having a different filter size from the other parallel networks.

14. The computer-implemented method of claim 7, further comprising:
determining, based on the predicted service pack version, an appropriate upgrade path to reach the compatible target service pack for the computer system.

15. A computer-implemented method, comprising:
fetching a list of discrete sub-component versions from a server node using an Application Programming Interface (API), the server node being part of a disaggregated hyper-converged infrastructure (dHCI) system;
inputting the fetched sub-component versions into a trained three-channel convolutional neural network (CNN) model;
predicting a base service pack version installed on the server node using the trained three-channel CNN model;
determining a target service pack version and a supported upgrade path to reach the target service pack version based on the predicted base service pack version; and
updating the server node by installing the target service pack version on the server node.

16. The computer-implemented method of claim 15, further comprising training the three-channel CNN model, the training comprising randomizing sub-component versions across supported base service pack versions to generate an augmented dataset.

17. The computer-implemented method of claim 16, wherein training the three-channel CNN model further comprises converting the augmented dataset into tokens using a predefined data map.

18. The computer-implemented method of claim 15, wherein each channel of the three-channel CNN model has a different filter size.

19. The computer-implemented method of claim 15, wherein predicting the base service pack version installed on the server node using the trained three-channel CNN model comprises:
concatenating outputs from all the channels of the trained three-channel CNN model into a single concatenated output; and
passing the single concatenated output through a dense layer for classification.

20. The computer-implemented method of claim 15, further comprising:
generating, using the trained three-channel CNN model, a probability score that indicates a confidence level of the prediction of the base service pack version; and
determining whether the probability score meets or exceeds a predetermined threshold value before proceeding with determining the target service pack version and the supported upgrade path.
